(19) United States
(12) Patent Application Publication
(10) Pub. No.: US 2008/0229859 A1
(43) Pub. Date: Sep. 25, 2008

(54) Eye module

(75) Inventors: Lin Hsiao, Taoyuan County (TW); Wai William Wang, Taoyuan County (TW); Fung-Hsu Wu, Taoyuan County (TW); Chen Peng, Taipei (TW); Chung-Cheng Chou, Taoyuan (TW); Bow-Yi Jang, Taichung (TW); Ta-Yuan Lee, Taipei (TW)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan Shien (TW)

(21) Appl. No.: 12/071,308

(22) Filed: Feb. 20, 2008

(30) Foreign Application Priority Data
Mar. 22, 2007 (TW) 96110001

(51) Int. Cl. G05G 11/00

(52) U.S. Cl. 74/479.01; 901/47

(57) ABSTRACT

An eye module is provided. The eye module includes a casing, an eyeball and a first driving element. The eyeball having a surface is disposed in the casing. The first driving element leans against the surface and drives the eyeball to rotate by a first friction force generated by rotating the first driving element.

This application claims the benefit of Taiwan application Serial No. 96110001, filed Mar. 22, 2007, the subject matter of which is incorporated herein by reference.

### BACKGROUND OF THE INVENTION

1. Field of the Invention

The invention relates in general to an eye module, and more particularly to an eye module which drives the eyeball to rotate by a friction force.

2. Description of the Related Art

Along with the rapid advance in science and technology, various electronic products are provided. Robot, which incorporates artificial intelligence (AI), mechanical design and circuit design, is a personalized electronic device and marks an important breakthrough. Robot can be used in automation processing or high risk operations in industrial manufacturing or used in household to assist people with their everyday activities and bring lots of joy to them.

Of the various personalized designs of robot, the eye module is a crucial design. The eye module can create various facial and emotional expressions for the robot. Conventional eye module of robot changes by way of the lights or is driven by a gear mechanism driven by a server motor. However, conventional eye module still needs to break through several bottlenecks.

Firstly, the performance is rigid. The performance of the eye module relies on the change of the light but is limited by the arrangement of the light, hence restricting the types of change. Besides, the way of driving the eye module by a gear mechanism is restricted by the pitch and position of the gear. When the gear mechanism rotates to a pitch, the eye module can only rotate to a fixed distance rigidly. Moreover, the eye module can only rotate towards a direction according to the disposition of the gear mechanism. Therefore, the performance of conventional eye module is very rigid.

Secondly, the volume is too large. Let the light module be taken for example. The light module is constituted by several sets of lights for generating different types of changes. The gear mechanism is constituted by elements such as gears, chains, and rods, and has a large volume. Therefore, when the light module or the gear mechanism is used, the volume of the eye module can not be effectively reduced.

Thirdly, manufacturing and design cost is too high. For an eye module to achieve various changes by light module and gear mechanism, a complicated structure is required, hence costing a lot in both the manufacturing cost and the design cost.

### SUMMARY OF THE INVENTION

The invention is directed to an eye module, which drives the eyeball to rotate by a friction force. The eye module and the driving method thereof have the following advantages of unlimited rotation angle and rotation direction, reaction to external objects, vivid and lively performance, small volume, low manufacturing and design cost, high accuracy, and smooth rotation.

According to a first aspect of the present invention, an eye module is provided. The eye module includes a casing, an eyeball and a first driving element. The eyeball having a surface is disposed in the casing. The first driving element leans against the surface and drives the eyeball to rotate by a first friction force generated by rotating the first driving element.

The invention will become apparent from the following detailed description of the preferred but non-limiting embodiments. The following description is made with reference to the accompanying drawings.

### BRIEF DESCRIPTION OF THE DRAWINGS

FIG. 1A is a perspective of an eye module according to a first embodiment of the invention;

FIG. 1B is a left view of the eyeball of FIG. 1A;

FIG. 1C is a top view of the eyeball and the first driving element of FIG. 1A;

FIG. 2 is a flowchart of a method of driving the eye module according to the invention;

FIG. 3A is a perspective of the eye module of FIG. 1A rotated to a pre-determined rotation angle θ1;

FIG. 3B is a left view of the eyeball of FIG. 3A;

FIG. 3C is a top view of the eyeball and the first driving element of FIG. 3A;

FIG. 4A is a perspective of the eye module of FIG. 1A rotated to a pre-determined rotation angle θ2;

FIG. 4B is a left view of the eyeball of FIG. 4A;

FIG. 4C is a top view of the eyeball and the first driving element of FIG. 4A;

FIG. 5A is a perspective of the eye module according to a second embodiment of the invention;

FIG. 5B is a left view of the eyeball of FIG. 5A; and

FIG. 6A is a perspective of the eye module of FIG. 5A rotated to a pre-determined rotation angle θ3;

FIG. 6B is a left view of the eyeball of FIG. 6A;

FIG. 6C is a perspective of the moving path of the pupil pattern of FIG. 6A;

FIG. 7A is a perspective of the eye module of FIG. 5A rotated to a pre-determined rotation angle θ4;

FIG. 7B is a left view of the eyeball of FIG. 7A;

FIG. 8 is a block diagram of the eye module according to a second embodiment of the invention;

FIG. 9 is a flowchart of the detection mechanism of the method of driving the eye module of the embodiment of the invention;

FIG. 10 is a flowchart of the feedback mechanism of the method of driving the eye module of the embodiment of the invention; and

FIG. 11 is a perspective of the eye module according to a third embodiment of the invention.

### DETAILED DESCRIPTION OF THE INVENTION

### First Embodiment

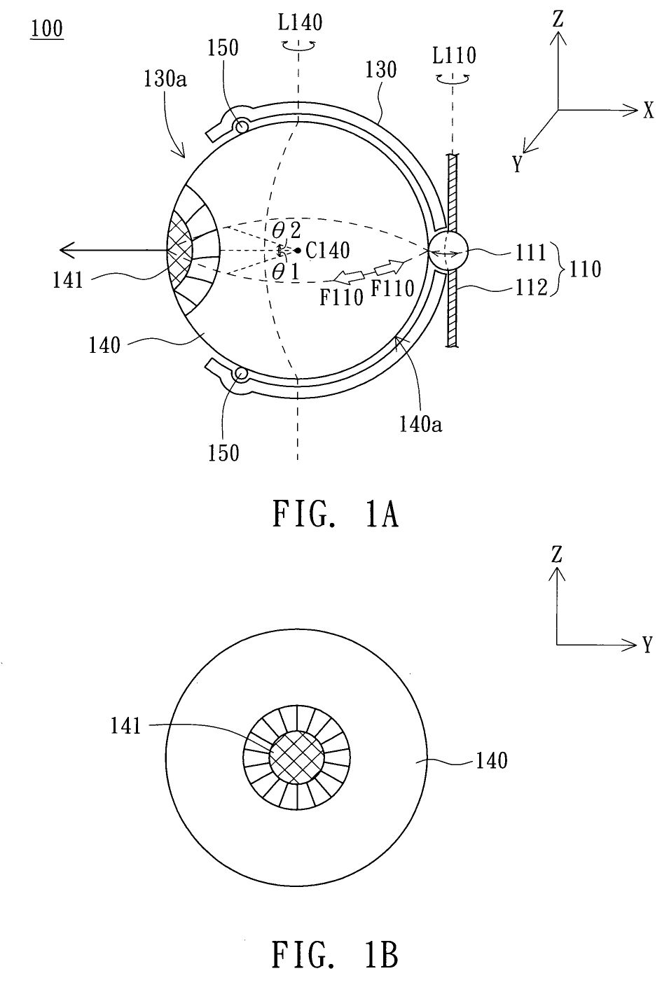

Referring to FIG. 1A, a perspective of an eye module 100 according to a first embodiment of the invention is shown. The eye module 100 includes a casing 130, an eyeball 140 and a first driving element 110. The casing 130 is disposed in an eye socket. The eyeball 140 having a surface 140a is disposed in the casing 130. The first driving element 110, which leans against the surface 140a, rotates the eyeball 140 by a first friction force F110 generated by rotating the first driving element 110. The structure and the driving method of the eye module 100 are elaborated below by way of various perspectives viewed from different angles and two flowcharts.

Referring to FIGS. 1A˜1C. FIG. 1B (the Y-Z plane) is a left view of the eyeball 140 of FIG. 1A. FIG. 1C (the X-Y plane) is a top view of the eyeball 140 and the first driving element 110 of FIG. 1A. The eyeball 140 has a pupil pattern 141. In FIG. 1A, the pupil pattern 141 faces the opening 130a of the casing 130. In FIG. 1B, viewing the eyeball 140 from the left, the pupil pattern 141 is located in the central position. As indicated in FIG. 1C, the first driving element 110 leans against the surface 140a and provides the first friction force F110 to the surface 140a for rotating the eyeball 140.

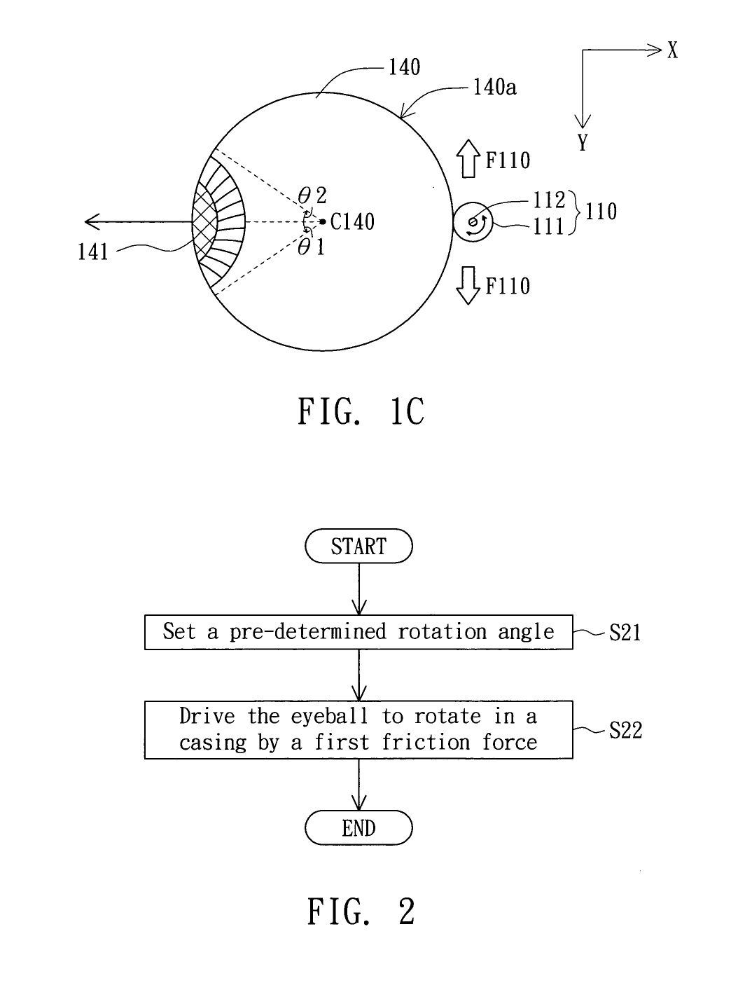

Referring to FIG. 2, FIG. 1A and FIG. 1B. FIG. 2 is a flowchart of a method of driving the eye module according to the invention. The driving of driving the eye module 100 at least includes the following steps. Firstly, the method begins at the step S21 of FIG. 2, a pre-determined rotation angle e1 or θ2 is set. Next, the method proceeds to the step S22 of FIG. 2, the eyeball 140 is driven by the first friction force F110 to rotate in the casing 130 (the casing 130 is illustrated in FIG. 1A).

As indicated in FIG. 1A and FIG. 1B, in the present embodiment of the invention, the eyeball 140 is a spherical structure. The first driving element 110 includes a first driving ball 111 and a first driving rod 112. The first driving ball 111 leans against the surface 140a. The first driving rod 112 is coupled to the first driving ball 111 for rotating the first driving ball 111. The first driving ball 111 rotates around a first central axis L110 (the first central axis L110 is illustrated in FIG. 1A) for providing a first friction force F110. The first central axis L110 is perpendicular to the first friction force F110, that is, the first central axis L110 is parallel to the Z-axial direction, and the first friction force F110 is parallel to the X-Y plane.

The step S2 of FIG. 2 further includes driving the first driving ball 111 to rotate around a first central axis L110 for rotating the eyeball 140. When the first driving ball 111 rotates around the first central axis L110 clockwise, the eyeball 140 concurrently rotates around the eyeball central axis L140 anti-clockwise (the eyeball central axis L140 is illustrated in FIG. 1A). The rotation angle of the first driving ball 111 is proportional to that of the eyeball 140, so that the first driving ball 111 can rotate the eyeball 140 anti-clockwise to any angle.

Likewise, when the first driving ball 111 rotates around the first central axis L110 anti-clockwise, the eyeball 140 concurrently rotates around the eyeball central axis L140 clockwise. The first driving ball 111 can also rotate the eyeball 140 clockwise to any angle.

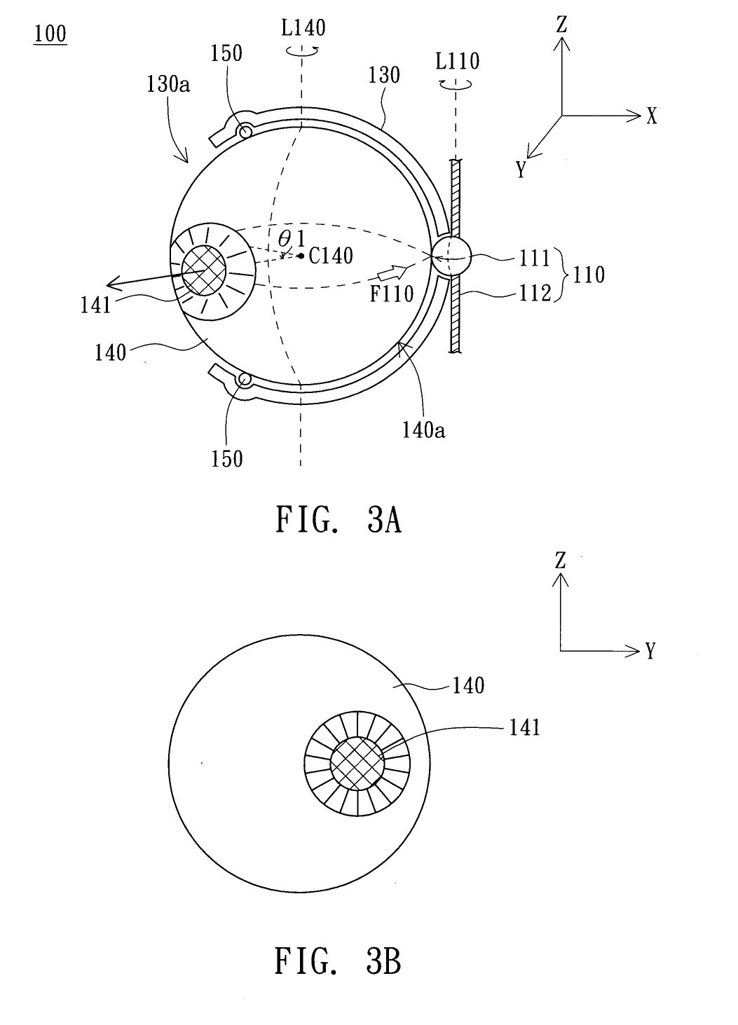

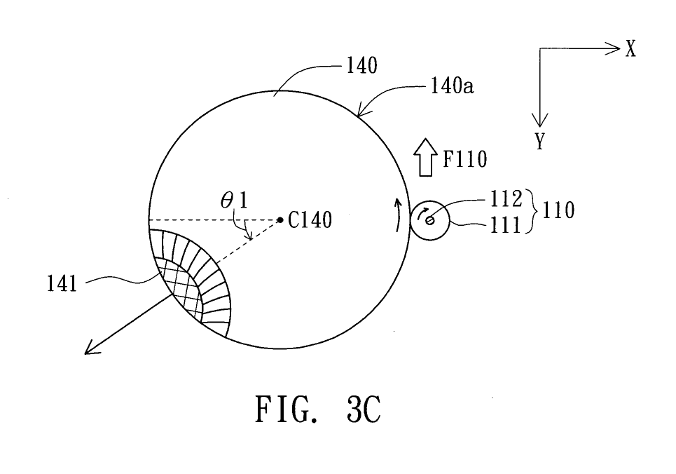

Referring to both FIG. 3A and FIG. 3C. FIG. 3A is a perspective of the eye module 100 of FIG. 1A rotated to a pre-determined rotation angle θ. FIG. 3C (the X-Y plane) is a top view of the eyeball 140 and the first driving element 110 of FIG. 3A. When the first driving ball 111 rotates the first central axis L110 clockwise, the eyeball 140 rotates around the eyeball central axis L140 anti-clockwise until the eyeball 140 is rotated to a pre-determined rotation angle θ1. The pre-determined rotation angle θ1 is determined according to actual needs, and is not limited to particular interval or range of angle, so that the rotation of the eyeball 140 is even flexible.

Referring to FIG. 3B (the Y-Z plane), a left view of the eyeball 140 of FIG. 3A is shown. When the eyeball 140 rotates around the eyeball central axis L140 anti-clockwise to a pre-determined rotation angle θ1, the pupil pattern 141 moves towards a direction of the Y-axis as if the eye is watching an object to the right.

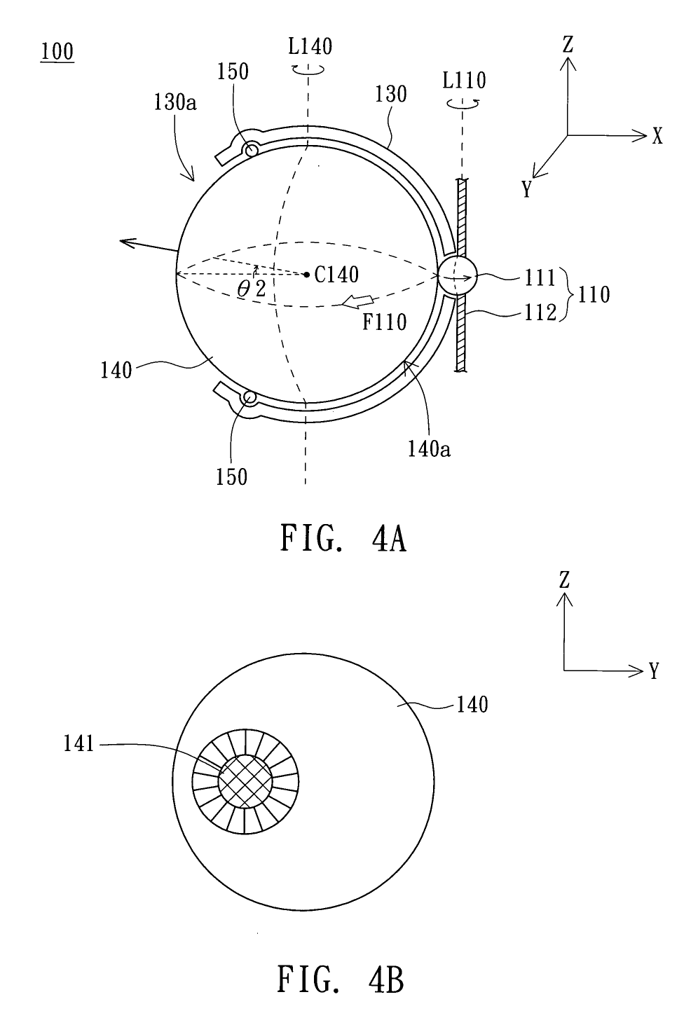

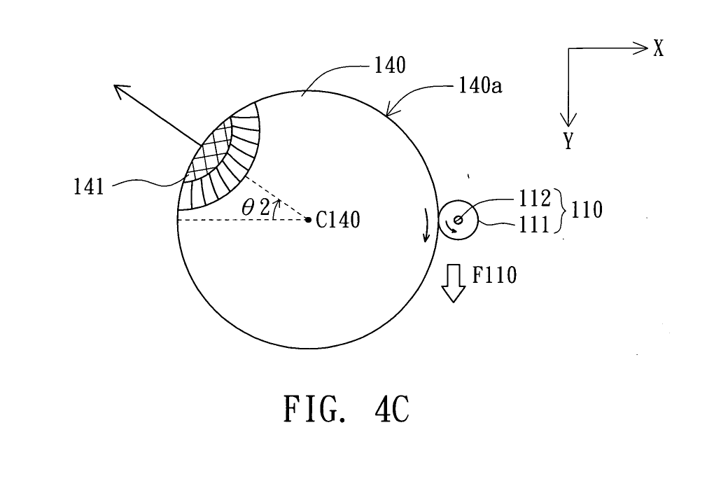

Referring to both FIG. 4A and FIG. 4C. FIG. 4A is a perspective of the eye module 100 of FIG. 1A rotated to a pre-determined rotation angle θ2. FIG. 4C (the X-Y plane) is a top view of the eyeball 140 and the first driving element 110 of FIG. 4A. When the first driving ball 111 rotates around the first central axis L110 anti-clockwise, the eyeball 140 concurrently rotates around the eyeball central axis L140 clockwise until the eyeball 140 is rotated to a pre-determined rotation angle θ2. The pre-determined rotation angle θ2 is determined according to actual needs, and is not limited to particular interval or range of angle, so that the rotation of the eyeball 140 is even flexible.

Referring to FIG. 4B (the Y-Z plane), a left view of the eyeball 140 of FIG. 4A is shown. When the eyeball 140 rotates around the eyeball central axis L140 clockwise to a pre-determined rotation angle θ2, the pupil pattern 141 moves towards the negative direction of the Y-axis as if the eye is watching an object to the left.

In addition to carrying the eyeball 140, the casing 130 further maintains a central point C140 of the eyeball 140 to be substantially positioned at a fixed position. During the step S22 of FIG. 2 of driving the eyeball 140 to rotate, the casing 130 is further used to maintain the central point C140 to be substantially at the fixed position, lest the eyeball 140 might deviate or fail to return to the original position.

Besides, the eye module 100 further includes at least a bearing 150. In the present embodiment of the invention, the eye module 100 includes two bearings 150 disposed between the casing 130 and the eyeball 140. The surface 140a does not contact the casing 130 directly, but rather, the surface 140a contacts the two bearings 150 and the first driving ball 111 by three contact points, hence reducing the resistance of the eyeball 140 to the minimum and enabling the eyeball 140 to rotate in the casing 130 smoothly.

Furthermore, preferably, the first driving ball 111 is made from an elastic material, so that the first driving ball 111 can lean against the surface 140a tightly for providing a sufficient first friction force F110.

### Second Embodiment

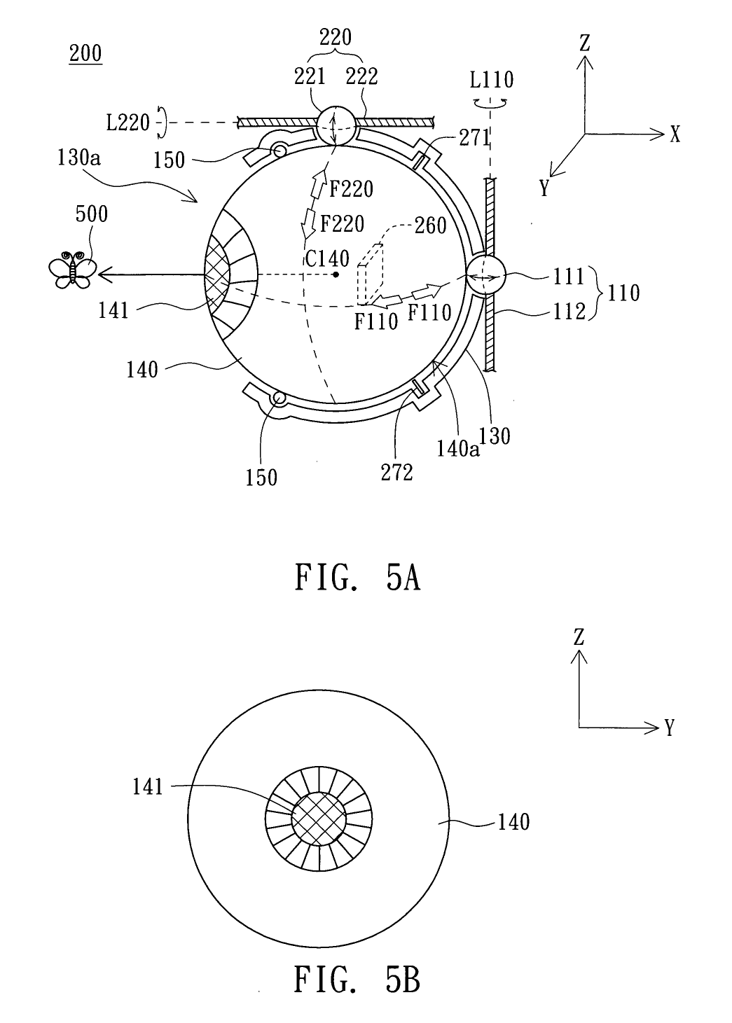

The eye module 200 of the present embodiment of the invention differs with the eye module 100 of the first embodiment in the second driving element 220, the control unit 250, the detecting unit 260 and the feedback unit 270, and the other similarities are not repeated here. Referring to FIG. 5A and FIG. 5B. FIG. 5A is a perspective of the eye module 200 according to a second embodiment of the invention. FIG. 5B (the Y-Z plane) is a left view of the eyeball 140 of FIG. 5A. The eye module 200 of the present embodiment of the invention further includes a second driving element 220. The second driving element 220, which leans against the surface 140a, rotates the eyeball 140 by a second friction force F220, so that the eyeball 140 rotates towards the direction of the combined force of the first friction force F110 and the second friction force F220.

Referring to both FIG. 2 and FIG. 5A. In the step S22 of FIG. 2, the eyeball 140 is concurrently driven to rotate by the first friction force F110 and a second friction force F220. The first friction force F110 is not parallel to the second friction force F220, that is, the first friction force F110 and the second friction force F220 are linear independent. The first friction force F110 and the second friction force F220 can move two-dimensionally as long as the first friction force F110 and the second friction force F220 are not parallel to each other. In the present embodiment of the invention, the first friction force F110 and the second friction force F220 are substantially perpendicular to each other.

The direction of the combined force of the first friction force F110 and the second friction force F220 is determined according to the magnitude and the duration of the first friction force F110 and the second friction force F220. Therefore, the direction of the combined force is not limited to be horizontal, vertical or a particular angle.

As indicated in FIGS. 5A and 5B, the second driving element 220 includes a second driving ball 221 and a second driving rod 222. The second driving ball 221 leans against the surface 140a. The second driving rod 222 is coupled to the second driving ball 222 for rotating the second driving ball 221. The second driving ball 221 rotates around a second central axis L220 for providing the second friction force F220, wherein the second central axis L220 is perpendicular to the second friction force F220. That is, the second central axis L220 is parallel to the X-axial direction, and the second friction force F220 is parallel to the Y-Z plane.

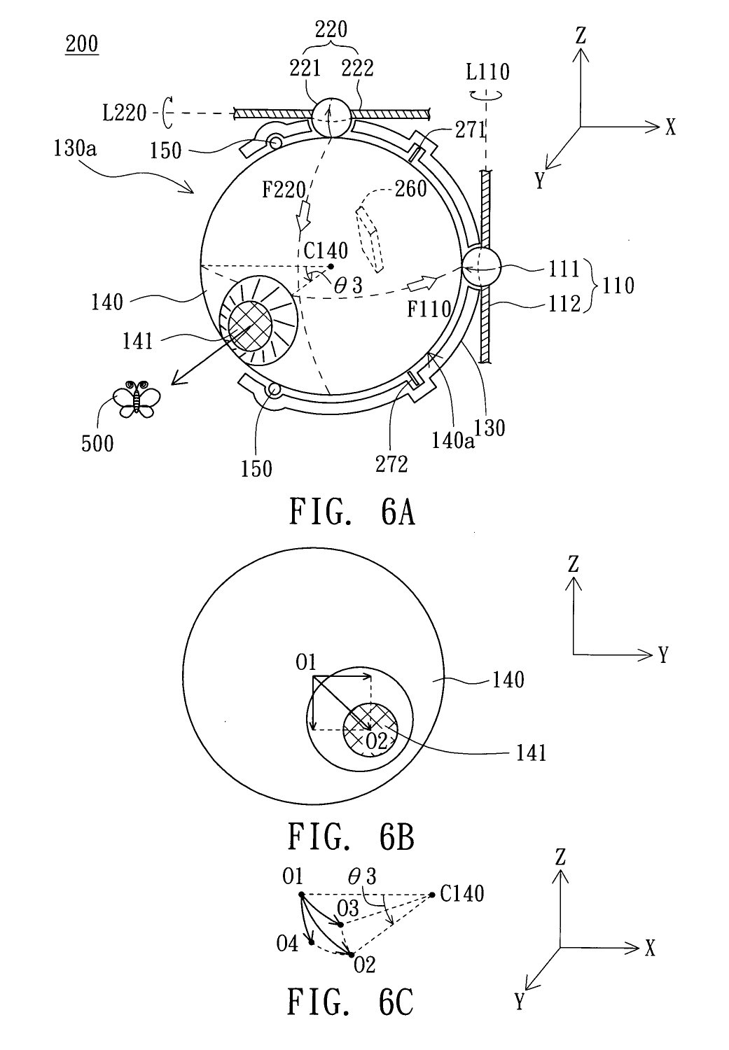

Referring to FIG. 6A, a perspective of the eye module 200 of FIG. 5A rotated to a pre-determined rotation angle θ3 is show. As indicated in FIG. 6A, when the eyeball 140 is driven to rotate by the first friction force F110 and a second friction force F220 concurrently, the eyeball 140 is rotated from left to right or from top to down until the eyeball 140 is rotated to the pre-determined rotation angle θ3.

Referring to both FIG. 6B and FIG. 6C. FIG. 6B (the Y-Z plane) is a left view of the eyeball 140 of FIG. 6A. FIG. 6C is a perspective of the moving path of the pupil pattern 141 of FIG. 6A. The first friction force F110 is for driving the pupil pattern 141 to move from the point O1 towards the point O3 along the surface 140a, and the second friction force F220 is for driving the pupil pattern 141 to move from the point O1 towards the point O4 along the surface 140a. When the first friction force F110 and the second friction force F220 concurrently drive the eyeball 140 to rotate, the pupil pattern 141 moves from the point O1 towards the point O2 along the surface 140a. As indicated in FIG. 6C, after the pupil pattern 141 is moved to point O2 from point O1, the pupil pattern 141 is located at the right bottom.

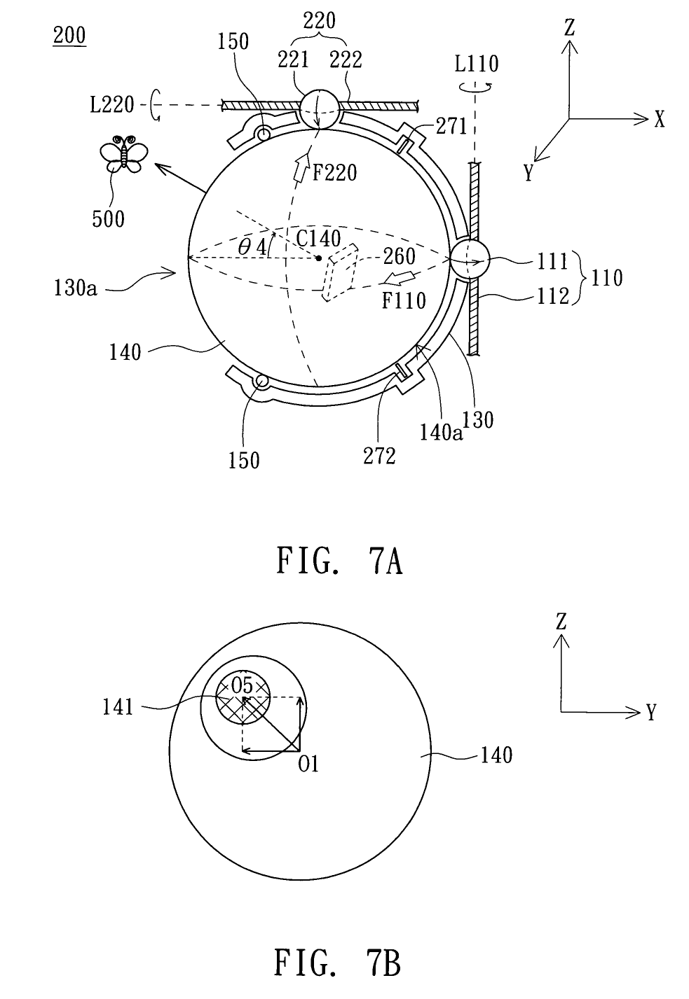

Referring to FIG. 7A, a perspective of the eye module 200 of FIG. 5A rotated to a pre-determined rotation angle θ4 is shown. When the eyeball 140 is concurrently driven by the first friction force F110 of another direction and the second friction force F220 of another direction, the eyeball 140 can further be rotated to another pre-determined rotation angle θ4.

Referring to both FIG. 7B, a left view of the eyeball 140 of FIG. 7A is shown. When the first friction force F110 and the second friction force F220 concurrently rotate the eyeball 140 to a pre-determined rotation angle θ4, the pupil pattern 141 moves from the point O1 to the point O5 along the surface 140a. After the pupil pattern 141 is moved to the point O5 from the point O1, the pupil pattern 141 is located at the left top.

Referring to FIGS. 5A, 6A and 7A. When the first driving rod 112 of the first driving element 110 and the second driving ball 111 rotate the eyeball 140, the eyeball 140 only contacts the second driving ball 221 of the second driving element 220 by one point, the rotation of the eyeball 140 will not be impeded. Likewise, when the second driving rod 222 and the second driving ball 221 of the second driving element 220 rotate the eyeball 140, as the eyeball 140 only contacts the first driving ball 111 of the first driving element 110 by one point, the rotation of the eyeball 140 will not be impeded either. Therefore, the eyeball 140 rotates smoothly.

Furthermore, preferably, the second driving ball 221 is made from an elastic material, so that the second driving ball 221 can lean against the surface 140a tightly for providing a sufficient second friction force F220.

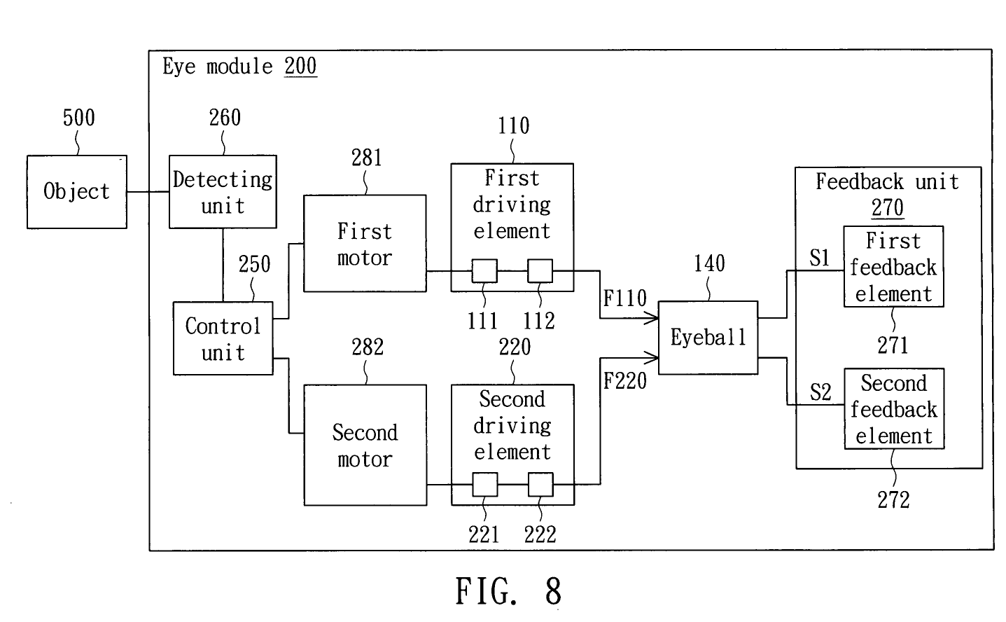

Referring to FIG. 8, a block diagram of the eye module 200 according to a second embodiment of the invention is shown. The eye module 200 further includes a control unit 250, a first motor 281 and a second motor 282. The control unit 250 is for controlling the first driving element 110 and the second driving element 220 to adjust the first friction force F110 and the second friction force F220. In the present embodiment of the invention, the first motor 281 and the second motor 282 are respectively coupled to the first driving rod 112 and the second driving rod 222. The control unit 250 controls the first driving element 110 and the second driving element 220 by the first motor 281 and the second motor 282. The control unit 250 is a central processing unit (CPU), a chip set, a circuitboard module, or a control keypad set. The control unit 250 respectively controls the rotating directions, the rotating speed or the rotating number of the first driving rod 112 and the second driving rod 222 to adjust the direction, the magnitude and the duration of the first friction force F110 and the second friction force F220.

As indicated in FIG. 8, the eye module 200 further includes a detecting unit 260. The detecting unit 260 is for detecting the shift position of an object 500. The detecting unit 260 can be a camera module, a charge-coupled device (CCD), a CMOS photo-sensing element or an ultra-red detector. The control unit 250 controls the first driving element 110 and the second driving element 220 to adjust the first friction force F110 and the second friction force F220 according to the shift position of the object 500.

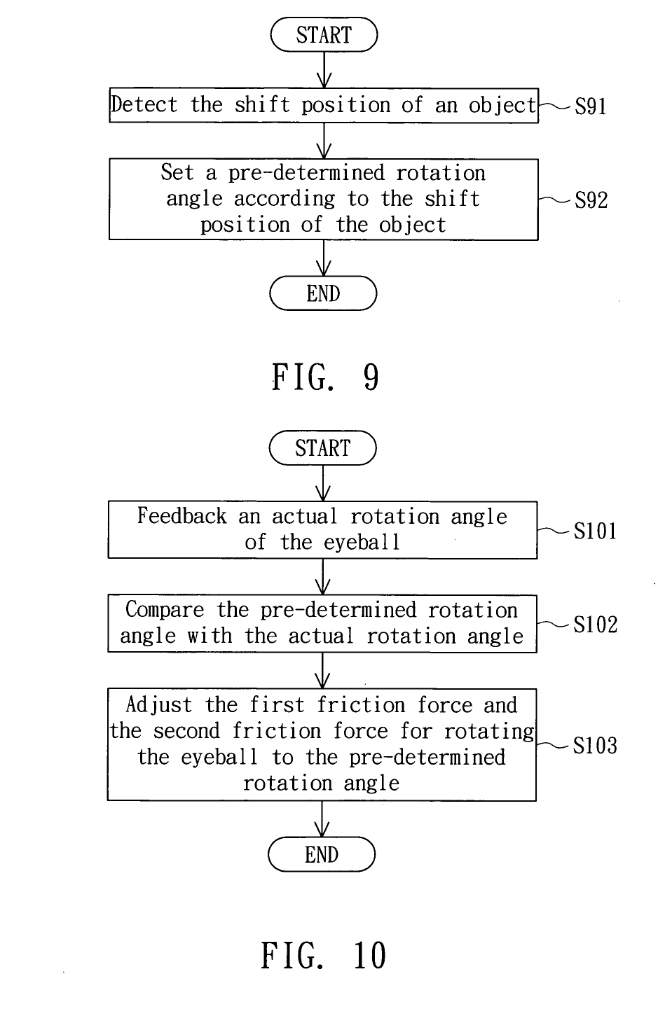

Referring to both FIG. 8 and FIG. 9. FIG. 9 is a flowchart of the detection mechanism of the method of driving the eye module 200 of the embodiment of the invention is shown. The method of driving the eye module 200 further includes a detecting mechanism. Firstly, the method begins at the step S91 of FIG. 9, the shift position of the object 500 is detected. As indicated in FIG. 5A, in the present embodiment of the invention, the object 500 is a butterfly. When the detecting unit 260 detects that the object 500 moves to the front of the eye module 200, the detecting unit 260 transmits the shift position of the object 500 to the control unit 250. Next, the method proceeds to the step S92 of FIG. 9, the control unit 250 sets a pre-determined rotation angle according to the shift position of the object 500 for enabling the pupil pattern 114 to be opposite to the object 500.

As indicated in FIG. 6A and FIG. 7A, the object 500 is further shift positioned to other positions. The detecting unit 260 detects the shift position of the object 500 for enabling the pupil pattern 141 to move along with the shift position of the object 500. Thus, the eye module 200 can react to the shift position of external object 500, making the performance of the eye module 500 even more vivid and lively.

Referring to FIG. 8, the eye module 200 further includes a feedback unit 270. The feedback unit 270 is for sensing an actual rotation angle of the eyeball 140 to generate an actual rotation angle signal including a first actual rotating angle signal S1 and a second actual rotating angle signal S2. The control unit 270 controls the first driving element 110 and the second driving element 220 to adjust the first friction force F110 and the second friction force F220 according to the actual rotation angle signal.

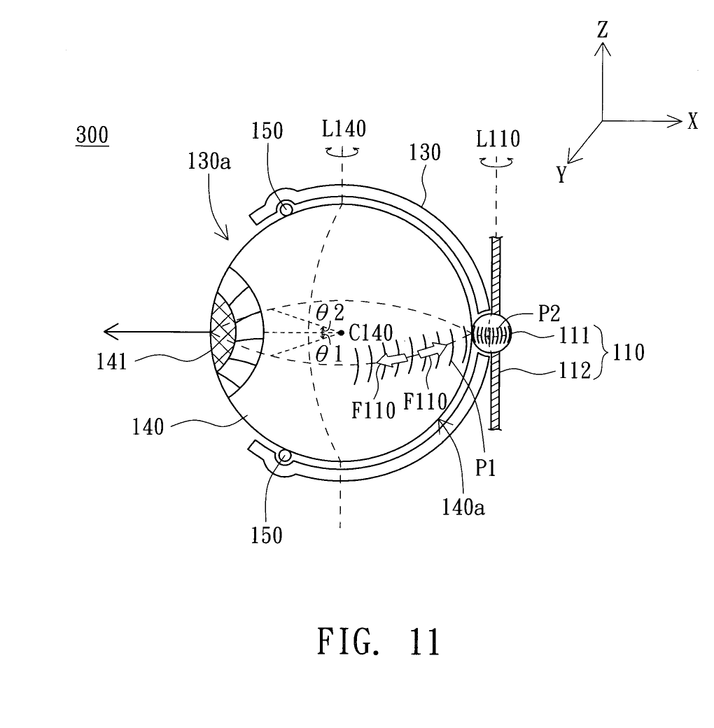

Referring to both FIG. 8 and FIG. 10. FIG. 10 is a flowchart of the feedback mechanism of the method of driving the eye module 200 of the embodiment of the invention. The method of driving the eye module 200 further includes a feedback mechanism. Firstly, the method begins at the step S101 of FIG. 10, the feedback unit 270 feedbacks an actual rotation angle of the eyeball 140. Next, the method proceeds to the step S102 of FIG. 10, the control unit 250 compares the pre-determined rotation angle with the actual rotation angle. Then, the method proceeds to the step S103 of FIG. 10, the control unit 250 adjusts the first friction force F110 and the second friction force F220 for rotating the eyeball 140 to the pre-determined rotation angle.

Referring to FIG. 5A, 6A or 7A. In the present embodiment of the invention, the feedback unit 270 further includes a first feedback element 271 and a second feedback element 272 (the designation of the feedback unit 270 is indicated in FIG. 8). The first feedback element 271 is for sensing the rotation angle of the eyeball 140 towards the direction of the first friction force F110 to generate the first actual rotating angle signal S1. The second feedback element 272 is for sensing the rotation angle of the eyeball 140 towards the direction of the second friction force F220 to generate the second actual rotating angle signal S2. As there are tolerances occurring when rotating the eyeball 140 by the first driving element 110 and the second driving element 220, the feedback unit 270 keeps sending the actual rotation angle of the eyeball 140 to adjust the first friction force F110 and the second friction force F220 real-time, hence improving the rotation accuracy of the eyeball 140.

Besides, the eyeball 140 of the present embodiment of the invention can be a hollowed sphere for accommodating the abovementioned elements such as the control unit 250, the detecting unit 260 or other elements, hence further reducing the volume of the eye module 200.

In addition to driving the eyeball 140 to rotate to the pre-determined rotation angle by the first driving element 110 and the second driving element 220 concurrently, the first driving element 110 and the second driving element 220 can alternately drive the eyeball 140 to rotate to a small angle until the eyeball 140 is rotated to the pre-determined rotation angle.

### Third Embodiment

The eye module 300 of the present embodiment of the invention differs with the eye module 100 of the first embodiment in that the eyeball 140 further has a plurality of first protruded traces P1 and the first driving ball 111 further has a plurality of second protruded traces P2, and other similarities are not repeated here. Referring to FIG. 11, a perspective of the eye module 300 according to a third embodiment of the invention is shown.

As indicated in FIG. 11, the first protruded traces P1 are substantially disposed on the surface 140a in parallel. In terms of the longitude and the latitude direction, all of the first protruded traces P1 are parallel to the longitude direction of the surface 140a. The first protruded traces P1 are disposed opposite to the first driving ball 111. That is, the first protruded traces P1 substantially correspond to the due back of the pupil pattern 141.

The second protruded traces P2 are substantially disposed on the surface of the first driving ball 111 in parallel. In terms of the longitude and the latitude direction, all of the second protruded traces P2 are parallel to the longitude direction of the surface of the first driving ball 111. The second protruded traces P2 are distributed around the first driving ball 111.

When the first driving ball 111 drives the eyeball 140 to rotate, the first protruded traces P1 and the second protruded traces P2 enhance the friction grip between the first driving ball 111 and the eyeball 140, so that the first driving ball 111 can stably drive the eyeball 140 to rotate.

According to the above embodiments of the invention, the first driving element 110 and the second driving element 220 are both exemplified by a driving rod for driving the driving ball to rotate. However, the first driving element and the second driving element can also be elements such as friction bump or friction belt. Any designs enabling a mechanism design to lean against the surface for providing a friction force are within the scope of technology of the invention. Besides, the number of the driving elements is not limited to one or two. Any number of driving elements is within the scope of technology of the invention.

The eye module and the driving method thereof disclosed in the above embodiments of the invention, which drive the eyeball to rotate in the casing by a friction force, at least have the following advantages:

Firstly, unlimited rotation angle. The eye module and the driving method thereof drive the eyeball to rotate by a friction force. The eye module can be rotated to any pre-determined rotation angles, which are free of interval restriction. The eyeball can be rotated to any pre-determined rotation angles by a friction force.

Secondly, unlimited rotation direction. The eye module can rotate the eyeball towards the direction of two combined friction forces by two non-parallel friction forces. The direction of the combined force is adjusted according to the magnitude, the direction and the duration of the friction forces applied, so that the rotating direction of the eyeball is not limited.

Thirdly, reaction to the shift position of external objects. The eye module and the driving method thereof further include a detecting unit and a detecting mechanism thereof for enabling to eyeball to react to the shift position of external objects as if the eye module is watching the object.

Fourthly, vivid and lively performance. As the rotation angle and rotation direction of the eyeball are not limited and can react to the shift position of external objects, the performance of the eye module is even more vivid and lively.

Fifthly, small volume. Compared with conventional light module and gear mechanism, the driving elements of the invention only occupy a small amount of volume. Besides, as electronic elements such as control unit or detecting unit can be disposed in the eyeball, the overall volume of the eye module is further reduced.

Sixthly, low manufacturing and design cost. The eye module of the invention has a simple structure, largely reducing the cost in material, assembly or design, hence having the advantage of large-scaled production and industry application.

Seventhly, high accuracy. The eye module and the driving method thereof further include a feedback unit and a feedback mechanism thereof for enabling the eyeball to adjust the magnitude or the duration of the friction forces applied, hence largely improving the rotation accuracy of the eyeball.

Eighthly, smooth rotation. As the eyeball only contact the first driving ball or the second driving ball by one contact point, the eyeball rotates smoothly and the rotation of the eyeball will not be impeded.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An eye module, comprising:
a casing;
an eyeball disposed in the casing, wherein the eyeball has a surface; and
a first driving element, which leans against the surface and rotates the eyeball by a first friction force generated by rotating the first driving element.

2. The eye module according to claim 1, further comprising a bearing disposed between the casing and the eyeball for enabling the eyeball to rotate smoothly in the casing.

3. The eye module according to claim 1, wherein the eyeball is a spherical structure.

4. The eye module according to claim 1, wherein the casing substantially maintains a central point of the eyeball at a fixed position.

5. The eye module according to claim 1, wherein the first driving element comprises:
a first driving ball, which leans against the surface;
wherein the first driving ball rotates around a first central axis for providing the first friction force, and the first central axis is perpendicular to the first friction force.

6. The eye module according to claim 5, wherein the first driving element further comprises:
a first driving rod coupled to the first driving ball for rotating the first driving ball.

7. The eye module according to claim 5, wherein the first driving ball is made from an elastic material.

8. The eye module according to claim 5, wherein the eyeball further has a plurality of first protruded traces, the first driving ball further has a plurality of second protruded traces, the first protruded traces are disposed opposite to the first driving ball, the first protruded traces are substantially disposed on the surface in parallel, and the second protruded traces are substantially disposed on the surface of the first driving ball in parallel.

9. The eye module according to claim 1, comprising:
a second driving element, which leans against the surface and rotates the eyeball by a second friction force generated by rotating the second driving element;
wherein the eyeball is rotated towards the direction of the combined force of the first friction force and the second friction force.

10. The eye module according to claim 9, wherein the first friction force is not parallel to the second friction force.

11. The eye module according to claim 9, wherein the first friction force and the second friction force are substantially perpendicular to each other.

12. The eye module according to claim 9, wherein the second driving element comprises:
a second driving ball, which leans against the surface;
wherein the second driving ball rotates around a second central axis for providing the second friction force, and the second central axis is perpendicular to the second friction force.

13. The eye module according to claim 12, wherein the second driving element further comprises:
a second driving rod coupled to the second driving ball for rotating the second driving ball.

14. The eye module according to claim 12, wherein the second driving ball is made from an elastic material.

15. The eye module according to claim 9, wherein the eye module further comprises:
a control unit for controlling the first driving element and the second driving element to adjust the first friction force and the second friction force.

16. The eye module according to claim 15, comprising:
a detecting unit for detecting the shift position of an object;
wherein the control unit controls the first driving element and the second driving element to adjust the first friction force and the second friction force according to the shift position of the object.

17. The eye module according to claim 15, comprising:
a feedback unit for sensing an actual rotation angle of the eyeball to generate an actual rotation angle signal;
wherein the control unit controls the first driving element and the second driving element to adjust the first friction force and the second friction force according to the actual rotation angle signal.

18. The eye module according to claim 17, wherein the feedback unit further comprises:
a first feedback element for sensing the rotation angle of the eyeball towards the direction of the first friction force to generate a first actual rotating angle signal; and
a second feedback element for sensing the rotation angle of the eyeball towards the second friction force to generate a second actual rotating angle signal.
